(19) United States
(12) Patent Application Publication
(10) Pub. No.: US 2005/0191287 A1
(43) Pub. Date: Sep. 1, 2005

(54) Bioinsecticide formulation consisting of Bacillus thuringiensis var israelensis, and its concerning manufacture proceedings

(75) Inventors: Elizabeth Gomes Sanches, Rio de Janeiro/RJ (BR); Ana Cristina Batista Da Silva, Rio de Janeiro/RJ (BR); Flavia Maria Abreu Campos, Rio de Janeiro, RJ (BR); Renata Alves Pinheiro Roberg, Rio de Janeiro, RJ (BR); Fernando Justino De Assuncao, Rio de Janeiro, RJ (BR)

Correspondence Address: NIXON & VANDERHYE, PC, 901 NORTH GLEBE ROAD, 11TH FLOOR, ARLINGTON, VA, 22203, US

(73) Assignee: Fundacao Oswaldo Cruz - FIOCRUZ, Rio de Janeiro (BR)

(21) Appl. No.: 11/072,365

(22) Filed: Mar. 7, 2005

Related U.S. Application Data
(63) Continuation of application No. 10/031,952, filed on Apr. 9, 2002, now abandoned.

(30) Foreign Application Priority Data
May 24, 2000 (BR) PI 0003314-6

(51) Int. Cl. A01N 63/00

(52) U.S. Cl. 424/93.461

(57) ABSTRACT

The principal aim of the present invention is to afford a bioinsecticide dry composition based on entomotoxines of Bacillus thuringiensis var israelensis, which is characterized by its practicability, economy and efficacy in controlling Dipteral insects, being, at the same time, ecologically safe.

The present invention is concerning to a bioinsecticide dry formulation consisting of entomotoxines of Bacillus thuringiensis var israelensis, which provides a practical, economical and effective larvicide activity, against Dipteral insects. This product presents a good shelf life when stored, and it contains ecologically safe addictive agents, affording the availability of active component in amount strong enough to get the desirable larvicide activity.

### BACKGROUND OF THE INVENTION

In general, the extermination of insects, especially those harmful to the agriculture, silviculture, and public health, involves the use of chemical insecticides. However, there are many drawbacks related to the use of this kind of products.

Chemical insecticides have a wide spectrum of action, being lethal not only to the target insects, but also to those that present some benefits for the agriculture, silviculture and public health. In addition, such insecticides are quite often toxics, not only to the animals but also to the man, well as they are able to pollute the environment. In addition, insects often develop organic resistance after following applications of chemical insecticides, which is awful for the desired extermination.

So, the use of bioinsecticides has gone beyond the expectative, becoming another strategy in the combat to these harmful insects.

Bioinsecticides make use of natural pathogen agents, or drugs produced by these pathogen agents, to combat insects in a much more effective and selective way, when compared to the chemical insecticides, once they have a narrower spectrum of action, killing only target insects. They have also the advantage to be degraded in the nature, and this way, they are not so harmful to the environment.

A bioinsecticide, widely employed in the biological control of insects producing diseases, is the Bacillus thuringiensis (Bt). The Bt is a movable, gram-positive bacterium, which may be found in the nature under a form of little rods (“batonettes”). This microorganism provides entomotoxines lethal to the insects, like crystal parasporals inclusions gotten during the period of sporulation, which cause death to the insects after ingestion.

These inclusions may change as to shape, number and composition, being made up of one or more proteins named delta-endotoxines that may oscillate between 27-140 kDa. In the insect's gastrointestinal tract, these proteins suffer alkaline and enzymatic degradations and they give origin to systemic and intestinal paresis, causing death of the insect. Delta-endotoxines are easily degraded and they differ from the other toxical substances because they have a specific toxic effect. In other words, they do not hit organisms other than the target insects. (Heimpel, A. M.; ANn. Ver, Entomology 12, 287-322, 1967. Höfte and Whiteley, Microbiological Reviews 53, 242-255, 1989).

Among strains of Bacillus thuringiensis isolated from the nature, the variety Bacillus thuringiensis var israelensis (Bti) has been commonly used in the combat to the Dipteral insects, whose extermination is very important for the public health (Payne et al, U.S. Pat. No. 5,888,976, 1999). Such insects are able to transmit Yellow Fever and Dengue, transmitted by Aedes aegypti.

A practical, economical and effective utilization of bioinseticides, like one obtained from Bacillus thuringiensis var israelensis, is intimately related to the amount of active component presents in bioinseticide formulations, such as the entire formulation.

Bioinsecticides formulations commonly used may provide a biomass of Bti, or its spores or its isolated entomotoxines. Besides, it is utterly necessary to show a good stability (shelf life) and, this way, they must include in their composition substances able to prevent the active component from degradation by chemical, biological, physical and natural agents (sunlight, for instance).

The document BR PI 8900938-0 reports bioinsecticides compositions made of amylolytic and proteolytic bacterium of genus Bacillus, lethal to insects of different classes. They involve bioinsecticide composition made of Bacillus thuringiensis var israelensis, toxic to Dipteral insects and known to provide, inert liquids, together with the active biomass, such as sorbitol, glycerol, toluol, giving the product a pasty consistence.

Meanwhile, a pasty formulation presents a high specific gravity. This way, it tends to remain on the bottom of the application area. This fact represents a drawback, especially in the case of target insects feeding and reproducing in areas near surfaces (like Dipteral insects), once the active component does not remain spreaded in the medium during the necessary time for a complete action.

The patent document WO 98/28984 suggests a composition, lethal to the insect's larvae, like Dipteral, dispensed as frozen granulated. However, by its own physical condition, such a formulation is not effective in places with hot weather (where there is a huge development of insects like Dipteral ones), once the active component is not spreaded enough for a complete action. Besides, this formulation is not practical because it requires short temperatures for its storing and transportation.

Thus, in order to get an effective larvicide activity, it is necessary the use of bioinsecticides formulations providing a high performance of dispersion of active components in the application areas. This way, it becomes easier to apply the correct dose, or in other words, the lethal dose of bioinsecticide.

But, while preparating bioinsecticide compositions, it is also very important to take into account no only the biology of target insect, but its habitat likewise, because the environment conditions (temperature, pH, presence of metals, solid materials in suspension, specific gravity, and so on) may change the performance of these compositions. Therefore, the features of the formulations, such as physical form and vehicle are very important for the effectiveness of active principle.

In addition, one needs bioinsecticides formulations characterized, not only by a high grade of dispersion concerning to the active component in the reproducing and feeding areas of target insects, but also because they are easy to be stored, packed, transported, and used.

Bioinsecticide dry formulations have been an alternative way of choice to solve these problems, once they are easy to store, to pack, to be taken to the infested areas (even those hard to get to), and then used, fulfilling all the requirements related to a high homogenization of active component in the application areas.

The document DE 41 33 889 is related to a dry bioinsecticide dispensed as effervescent tablets, which are used against Dipteral type insects. Meanwhile, in spite of the active component is homogeneously delivered, there is no addictives to become possible its permanence in the environment warranting a 100% death of larvae, even during some time after the application of the product.

A formulation able to kill 100% larvae with a minimum of permanence in the area is of a capital importance to get an effective larvicide activity. This long-term action of active component, together with a high grade of dispersion, in the application area, and consequently easy to administrate the correct dose, become lower the number of necessary applications. This fact means an important factor under economical and practical points of view, especially for the places hard to get to.

The patent documents E 761 096 and U.S. Pat. No. 5,560,909 are examples of how to get bioinsecticides dry formulations made from bacterium genus Bacillus, able to remain in the feeding and reproduction areas of the target insects, such as Dipteral, becoming easy the long-term action of active component, giving place to an effective biological control of the insects, even in case of these targets are mosquito's larvae. Meanwhile, such formulations provide, among others, unbiodegradable polymer compounds. Such a fact means a menace to the environment.

This way, it becomes utterly necessary the fabrication of a bioinsecticide dry formulation, having suitable carrier addictives, which be able to do an effective biological control of Dipteral insects by means of a long-term action of the active component spreaded in the application area, but, above all, causing no risks to the ecological environment. Then, it will be possible to get a bioinsecticide with so important qualifications, not only as to its practical, economical, and effective action, but also as to be ecologically safe.

### SUMMARY OF THE INVENTION

The principal aim of the present invention is to afford a bioinsecticide dry composition based on entomotoxines of Bacillus thuringiensis var israelensis, which is characterized by its practicability, economy and efficacy in controlling Dipteral insects, being, at the same time, ecologically safe.

Thus, the principal objective of this invention is to get a bioinsecticide dry formulation, comprising:

a) entomotoxines, pure or not, of Bacillus thuringiensis var israelensis.

b) chemical dryers.

c) dispersing agents.

d) agglutinant/humectant agents.

e) protectors against sunlight and

f) optionally: diluent, lubricant and neutralizing agents.

A first embodiment of this invention is related to a bionsecticide formulation dispensed as dry powder, or tablets, comprising addictives carrying the entomotoxines, pure or not, selected in way to afford a high dispersion of the active component in the application area, but bringing about no risks to the environment.

A second embodiment of this invention is related to the proceedings for obtention of bioinsecticide formulation, delineated by the following phases:

I. Development of Bacillus thuringiensis var israelensis by means of fermentation in a suitable growth medium, where the not spent metabolites/nutrients are not harmful to the environment and they may be used in a industrial scale.

II. The recovery of toxical biomass, or its spores, or only entomotoxines gotten in the phase (I) by means of a suitable process of recuperation, able to keep the toxical activity of entomotoxines (pure or not).

III. Sequential addition of chemical dryers, and other addictives to the toxical biomass, or to the spores, or only to the entomotoxines recovered as mentioned in phase (II). Occasionally, the accomplishment of a dehidratation phase between joining the chemical dryers and the others addictives.

IV. Dehidratation of the blend gotten in phase (III), by means of process able to keep the toxical activity of entomotoxines, pure or not, in order to obtain a formulation dispensed as dry powder.

V. Optional addition of addictives, as diluents, lubricants, and neutralizing agents to the dry powder gotten in the phase (IV), in order to obtain the tablets.

### DETAILED DESCRIPTION OF THE INVENTION

The principal aim of this invention is to afford a dry formulation consisting of entomotoxines of Bacillus thuringiensis var israelensis, presenting an effective larvicide activity against Dipteral insects, and is characterized to be practical, economical and with no harm to the environment.

For a more complete understanding, we set forth, here bellow, the meanings of terms used in this project:

1. Effective larvicide activity: being able to kill 100% larvae within a minimum time of permanence in the application area; having a good stability during storage (shelf life), keeping practically unchanged the initial larvicide activity, comprising components able to prevent the active component from degradation by physical, chemical, and biological action produced by natural agents in the application areas; comprising addictives producing availability of active component in enough amount within the longest sphere of action possible (for instance, dispersing agents, substances that increase the humectant effect).

2. Economical larvicide activity: resulting of its effectiveness in the biological control of Dipteral insects, that would become easier the administration of correct dose, and a long-term action of active component, reducing the number of applications.

3. Practical larvicide activity: being employed in places hard to get to and easy to be stored, packed, transported to the infested places.

4. No harm to the environment (ecologically safe): meaning no change to the ecological balance, acting in a selective way (lethal only to the target insects, and no harmful to the other ones existing in the application area); being biodegradable within a suitable time, no to cause deposition of detritus, toxical to the fauna and flora in the application area; no clouding, in order to avoid a possible unbalance in the environment oxygenation; providing no metabolites and/or nutrients not spent when manufacturing the toxical biomass, which would be harmful to fauna and flora in the application area.

Isolation and growth of Bacillus thuringiensis var israelensis may be done in those known conditions, published in technical literature, well as the fermentation phase, to obtain the active biomass.

Meanwhile, the fermentation medium must provide:

a) Nitrogen survey substances, selected from the group consisting of industrial remains rich in proteins, soya proteins, urea, yeast extract.

b) Carbon survey substances, selected from the group consisting of mannitol, dextrose and sucrose.

c) Micronutrients survey substances, selected from blends of salts enclosing MgSO₄, MnSO₄, ZnSO₄, FeSO₄, and CaCl₂.

d) Sodium chloride, employed to keep cell viability.

The selection of the most suitable growth medium is of capital importance to get a bioinsecticide in an industrial scale. Additionally, in case of formulations whose entomotoxine is not purified (isolated), the components of growth medium are to be chosen in such a way, that their remains are not harmful to the environment.

In the present invention, the components of growth medium are selected in a way to satisfy the ratio between the possibility of utilization in an industrial scale, and the minimization of lethal effects caused by the fermentation remains.

For the accomplishment of this invention, the growth medium of choice is made up of: amino-fertile (1.5-3.0% w/w), soya protein (1.0-1.5% w/w), urea (0.1-0.2% w/w), mannitol (0.6-0.8% w/w), sodium chloride (0.1-0.2% w/w) besides a blend of salts (0.05-0.08% w/w) according to Table 1.

TABLE 1
Components and their respective concentrations in the blend of salts.

| COMPONENTS | | CONCENTRATION (% w/w) |
|---|---|---|
| Mg | SO₄ | 65.1% |
| Mn | SO₄ | 4.4% |
| Zn | SO₄ | 4.4% |
| Fe | SO₄ | 4.4% |
| Ca | Cl₂ | 21.7% |

In such conditions, the cell viability is 1.8-3.8×10¹⁰ cfu (colonies forming units)/ml.

At the end of fermentation, the resulting solid material that makes up the toxical biomass encloses Bti entomotoxines, spores, torn and unchanged cells, well as solid remains coming from the fermentation and the resulting metabolites.

In the present invention, both toxical biomass of Bti, and its spores or only pure entomotoxines may be used as bioinsecticides formulations, being recovered by methods commonly used, since they are not harmful to the effectiveness of active component (entomotoxine), being this pure or not.

Toxical biomass, for instance, may be recovered through the centrifugation technique, in the procedures with membranes (among others).

After recovering entomoxines of Bacillus thuringiensis var israelensis, pure or not, one begins to develop the bionsecticide dry formulation, dispensed as dry powder, that orovides:

a) entomotoxines, pure or not, of Bacillus thuringiensis var israelensis.

b) chemical dryers.

c) dispersing agents.

d) agglutinant/humectant agents.

e) protectors against sunlight.

This way, the active biomass of Bti, or its recovered spores, or even its purified entomotoxines are blended with the chemical dryers, selected from diatomite, bentonite, calcium phosphate, calcinated silica, (for instance, Cab-o-sil®), diatomaceous earth, calcite, clay, silica, kaolin, dolomite, leucite, and montmobilonite.

In one preferred embodiment of the present invention, the chemical dryers chosen are: dolomite, bentonite, calcium phosphate, and Cab-o-sil®. Such dryers are, by preference, within a ratio of 0.1-10% w/w.

So, dispersing agents such as methylcellulose, ammonium and calcium alginate, sodium alginate, lactose, carboximethylcellulose, celluloses, bentonite are employed together with agglutinant/humectant agents as, for instance, polyoxyethylenes stearates (as Mirj 45®) sodium laurylsulfate, and monoleate of polyoxyethylenes sorbitans.

The active component of this present invention (Bti entomotoxines pure or not) is also protected against degradation caused by sunlight. Such a protection may be obtained blending the active principle with water-soluble agents. In an alternative way, the particles of the active component may be coated with protecting agents such as TiO₂, as shown in the document WO 98/15183.

The dispersing and agglutinant agents used in one preferred embodiment of the present invention are, respectively, methylcellulose and Mirj 45®. By preference, they are present in a ratio of 0.1-10% w/w.

The blend of active biomass, or spores, or even pure entomotoxines with addictives must be done in a sequential way, followed by dehydratation. Between the stages of addiction of chemical dryers and other addictives (dispersing, agglutinant/humectant agents and protectors against sunlight), a dehydratation phase may be carried out.

This dehydratration may be done by means of known techniques of drying and supposed to be applied in industrial scale, such as drying with or without forced ventilation, drying by rotative vaporizer/sprinkler, freeze-drying and so on, always avoiding degradation of active component on account of high temperatures.

The final blend is then grinded until obtaining a dry powder, whose particle size must be between 50-100 mesh and humidity grade in about 5-15% w/w. For accomplishment of this invention the ranges of choice are 60-80 mesh and 9-11% w/w for particle size and humidity, respectively.

In this invention the bioinseticide formulation dispensed as powder, providing a toxical activity between 500-1500 TIU (Toxic International Units)/mg expressed in dry powder, is one of the applications of choice for the biological control of Dipteral insects. Expressing in biomass terms, this toxical activity is equivalent to 10⁸-10¹² ufc (colonies forming units)/g toxical biomass.

But, in one preferred embodiment of this invention, such bioinsecticide formulations are dispensing as 100-200 mg tablets (made from the dry powder, formerly mentioned), comprising:

a) entomotoxines, pure or not, of Bacillus thuringiensis var israelensis.

b) chemical dryers.

c) dispersing agents.

d) agglutinant/humectant agents.

e) protectors against sunlight.

f) diluent, lubricant and neutralizing agents.

Thus, the formulation dispensed as dry powder, that is, the formulation made up by blending the components from (a) to (e) is put together with several addictives, such as neutralizing, diluent and lubricant agents, and so on. Among neutralizing and diluent agents one finds sodium bicarbonate, micronized celluloses (Avicel®), or other celluloses, mono-hydrated lactose, apatite, granulated mannitol, calcinated clay, kaolin, leucite, talc, and so on. As lubricants, one may say polyethyleneglicols (PEG), with molecular weight between 2000 and 6000, and stearic acid.

In one preferred embodiment of this invention, neutralizing and diluent agents selected are sodium bicarbonate, Avicel®, and mono-hydrated lactose (by preference in a ratio of 10-70% w/w) and the lubricant agent corresponds to PEG 6000 (by preference within a range of 1-5% w/w).

In the present invention, the active components are within 5-25% of the final weigh of the formulation, dispensed as tablets.

In one preferred embodiment of this invention, the tablets show a formulation according to table 2.

TABLE 2
Formulation of tablets:

| COMPONENTS | PERCENTAGE (% w/w) |
|---|---|
| Active component | 10.0-20.0 |
| Micronized cellulose | 52.0-47.0 |
| Mono-hydrated lactose | 18.0-15.5 |
| Sodium bicarbonate | 18.0-16.0 |
| Atomizated PEF 6000 | 2.0-1.5 |

The present invention is described in details according to the following examples. It is important and necessary to put in relief, that the present invention is not concerned only to these examples, but it also includes changes and modifications inside the limits it works.

### EXAMPLE 1

Attainment of Active Biomass of Bacillus thuringiensis var israelensis:

The strain of Bacillus thuringiensis var israelensis IPS 82 was employed to get the active biomass.

The table 3 shows the fermentation medium used.

TABLE 3
Fermentation medium:

| RAW MATERIAL | PERCENTAGE (% w/w) |
|---|---|
| Amino-fertile* | 1.5 |
| Soya protein | 1.5 |
| Urea | 0.1 |
| Mannitol | 0.7 |
| Sodium chloride | 0.2 |
| Blend of salts | 0.06 |

*Industrial remains rich in proteins.

The fermentation was carried out under 33° C. for 24 hours. The assays have been developed in a scale of 50 ml, in 250 ml Erlenmeyer's flasks, under stirring in a shaker, within a range of 150-270 r.p.m..

The suitable cell viability was 3.8×10¹⁰ ufc (colonies formatting units)/ml.

### EXAMPLE 2

Recovering Active Biomass of Bacillus thuringiensis var israelensis:

After fermentation phase, the solid material (involving Bti crystal protein), their spores, their torn and intact cells, well as solid remains deriving from the fermentation medium) were recovered by means of a bioseparation method by membrane vortex.

The operational conditions of this process is shown in the table 4.

TABLE 4
Operational Parameters - Bioseparation Method by Membrane Vortex.

| Membrane | M × 10-poliacrilonitrile | |
|---|---|---|
| Flow | 125 | m/s |
| Pression | 23-26 | psi |
| Torsion | 11-14 | psi |
| Rotation | 2000 | rpm |
| Time | 180 | minutes |

By means of this procedure one has gotten a 20% yield over the initial volume of active mass.

### EXAMPLE 3

Bioinsecticide Formulation Dispensed as Dry Powder:

The biomass recovered according to the procedure mentioned in the former example, was blended with the chemical dryers diatomite, bentonite, tricalcium phosphate and Cab-o-sil®, in the amounts showed in-table 5.

TABLE 5
Amount of Active Biomass and Chemical Dryers, Employed in
the Formulation Dispensed as Dry Powder.

| SUBSTANCE | AMOUNT | |
|---|---|---|
| Active biomass | 400 | ml |
| Diatomite | 4 | g |
| Bentonite | 2 | g |
| Tricalcium phosphate | 2 | g |
| Cab-o-sil ® | 4 | g |

Diatomite, bentonite, tricalcium phosphate and Cab-o-sil® were grinded and homogenized. This blend was added to the Bti active mass, under constant stirring. The resulting blend was dried in a stove under 37° C.

After 36 hours, the dry powder was grinded in order to obtain a fine and homogeneous powder (called P) weighing 27.29 g. After this step, 0.5458 g (2% of the weight of P) methylcellulose, previously grindered, were added to the dry powder. The resulting blend was then homogenized.

Separately, 0.2729 g (1% total weigh of P) of Mirj® was heated in a water bath until complete fusion, adding stepwise 50 ml distilled water, under vigorous stirring. To this solution it was added the sun filter Eusolex 6007®.

Then, the former solution was poured slowly over the dry powder P blended with the methylcellulose. The resulting blend was homogenized and placed in a stove under 30° C. for 24 hours.

The resulting dry powder (about 26.7 g), with a humidity grade of 10.83% w/w, was grinded and screened by means of a 70-mesh sieve (tamis).

The cellular concentration, estimated by means of the technique of counting plates, was 7×10¹¹ ufc (colonies forming units)/g toxical biomass.

Thus, we have gotten the bioinsecticide formulation based on Bacillus thuringiensis var israelensis, dispensed as dry powder, called P₁.

### EXAMPLE 4

Bioinsecticide Formulation Dispensed as Tablets:

The dry powder (P₁), obtained in the former example, was blended with the diluents Avicel PH102 and mono-hydrated lactose, with the sodium bicarbonate (neutralizing agent), and also with atomizated PEG6000 (lubricant). This blend of powders was put under a rotative compression, and it was turned out into tablets of bioinsecticide.

We have obtained 20 or 15 mg tablets comprising P₁ dry powder as active component.

The tables 6 and 7, show the amounts of agents employed to obtain 1 and 600 tablets, respectively.

TABLE 6
Adjuvant Agents Employed in the Procedure of Tablets
Comprising 20 mg of Active Component

| | | AMOUNTS | |
|---|---|---|---|
| ADJUVANT | PERCENTUAL | ONE TABLET | 600 TABLETS |
| AGENTS | (% p/p) | (mg) | (g) |
| Concentrated Po P₁ | 16.67 | 20.00 | 12.00 |
| Avicel PH 102 | 48.32 | 57.99 | 34.79 |
| Mono-hydrated | 16.67 | 20.00 | 12.00 |
| Lactose | | | |
| Sodium | 16.67 | 20.00 | 12.00 |
| bicarbonate | | | |
| Atomizated PEG | 1.67 | 2.01 | 1.21 |
| 6000 | | | |

TABLE 7
Adjuvant Agents Employed in the Procedure of Tablets
Comprising 15 mg of Active Component

| | | AMOUNTS | |
|---|---|---|---|
| ADJUVANT | PERCENTUAL | ONE TABLET | 600 TABLETS |
| AGENTS | (% p/p) | (mg) | (g) |
| Concentrated Po P₁ | 12.50 | 15.00 | 9.00 |
| Avicel PH 102 | 50.74 | 60.89 | 36.53 |
| Mono-hydrated | 17.50 | 21.00 | 12.60 |
| Lactose | | | |
| Sodium | 17.50 | 21.00 | 12.60 |
| bicarbonate | | | |
| Atomizated PEG | 1.76 | 2.11 | 1.27 |
| 6000 | | | |

### EXAMPLE 5

Assays Against Larvae of Aedes aegypti Mosquito:

Tablets proving 20 and 15 mg of the active component were tested as to the larvicide activity against Aedes aegypti mosquito.

For each 10 liters water, it was placed one tablet. Then, by the periodical introduction of Aedes aegytpti's larvae, one has estimated its mortality rate.

The results for both tablets have revealed that the respective amounts of active component have shown an effective larvicide activity, giving a 100% mortality of larvae, which remained up to 19 days, at least, in areas under sunlight, and 28 days in areas in the shade.

1. Bioinsecticide formulation based on entomotoxines obtained from Bacillus thuringiensis var israelensis with toxical activity against Dipteral insects characterized by to be dispensed as dry powder with a toxical activity between 500-1500 ITU (International Toxical Units)/mg dry powder, besides having addictives as chemical dryers, dispersing, agglutinant/humectant agents and protectors against sunlight, which become easy the permanence of active component in the application area for at least 10 days, maintaining stable its toxical activity for at least 6 months, with no harm to the ecosystem.

2. Bioinsecticide formulation according to claim 1 wherein the Bti entomotoxine is under an impure form as toxical biomass or Bti spores.

3. Bioinsecticide formulation according to claim 1 wherein the Bti entomotoxine is under an isolated form as toxical biomass or Bti spores.

4. Bioinsecticide formulation according to claim 1 wherein the chemical dryers have been selected among diatomaceous earth, calcite, clay, silica, kaolin, diatomite, bentonite, dolomite, calcium phosphate, leucite, montmobilonite, and calcinated silica.

5. Bioinsecticide formulation according to claim 4 wherein the chemical dryers are 0.1-10% w/w diatomite, 0.1-10% w/w bentonite, 0.1-10% w/w calcium phosphate and 0.1-10% w/w calcinated silica.

6. Bioinsecticide formulation according to claim 1 wherein the dispersing agents have been selected from calcium and ammonium alginate, sodium alginate, lactose, carboxymethylcellulose, methylcellulose, celluloses and bentonite.

7. Bioinsecticide formulation according to claim 6 wherein the dispersing agent has been the methylcellulose, in 0.1-10% w/w.

8. Bioinsecticide formulation according to claim 1 wherein the agglutinant/humectant agents have been selected among sodium laurylsulfate, monoleate of polyoxyethylenes sorbitans and polyoxyethylenes stearates.

9. Bioinsecticide formulation according to claim 8 wherein the polyoxyethylenes stearates are present in a range of 0.1-10% w/w.

10. Bioinsecticide formulation based on entomotoxines from Bacillus thuringiensis var israelensis with toxical activities against Dipteral insects, characterized to be dispensed as tablets with 5 to 25% composition of claim 1 and neutralizing, diluent and lubricant agents.

11. Bioinsecticide formulation according to claim 10 wherein the neutralizing and diluent agents have been selected among sodium bicarbonate, apatite, granulated mannitol, micronized cellulose or other celluloses, monohydrated lactose, kaolin, leucite and talc.

12. Bioinsecticide formulation according to claim 11 wherein the neutralizing agent is sodium bicarbonate in a range of 10-70% w/w and the diluent agents are micronized cellulose and mono-hydrated lactose, both in a range of 10-70% w/w.

13. Bioinsecticide formulation according to claim 10 wherein the lubrificant agent is polyethylene glycol 6000 in a range of 1-5% w/w.

14. Preparation procedure of a bioinsecticide formulation with toxical activity against Dipteral insects characterized by the following phases:
I. Development of Bacillus thuringiensis var israelensis by means of fermentation in a suitable growth medium, where the not spent metabolites/nutrients are not harmful to the environment and they may be used in a industrial scale.
II. The recovery of toxical biomass, or its spores, or only entomotoxines gotten in the phase (I) by means of a suitable process of recuperation, able to keep the toxical activity of entomotoxines (pure or not).
III. Sequential addition of chemical dryers, and other addictives to the toxical biomass, or to the spores, or only to the entomotoxines recovered as mentioned in phase (II). Occasionally, the accomplishment of a dehidratation phase between joining the chemical dryers and the others addictives.
IV. Dehidratation of the blend gotten in phase (III), by means of process able to keep the toxical activity of entomotoxines, pure or not, in order to obtain a formulation dispensed as dry powder.
V. Optional addition of addictives, as diluents, lubricants, and neutralizing agents to the dry powder gotten in the phase (IV), in order to obtain the tablets.

15. Process according to claim 14 wherein the fermentation medium include:
I. Nitrogen survey: one or more substances selected from the group consisting of industrial remains riches in proteins, soya protein. urea, extract of yeast.
II. Carbon survey: one or more substances selected from the group consisting of mannitol, dextrose and sucrose.
III. Micronutrients survey: blend of salts enclosing MgSO₄, MnSO₄, FeSO₄ and CaCl₂.
IV. Sodium chloride, employed to keep cellular viability.

16. Process according to claim 15 wherein the fermentation medium components comprehend 1.5-3.0% w/w of amino-fertile, 1.0-1.5% w/w of soya protein, 0.1-0.2% w/w of urea, 0.6-0.8% w/w of mannitol, 0.1-0.2% w/w of sodium chloride and 0.05-0.08% w/w of a blend of salts constituted by 65.1% w/w of MgSO₄, 4.4% w/w of MnSO₄, 4.4% w/w of ZnSO₄, 4.4% w/w of FeSO₄ and 21.7% w/w of CaCl₂.

17. Process according to claim 14 wherein the recovery of toxical biomass has been carried out by bioseparation with membrane vortex.

18. Process according to claim 14 wherein the others addictives are dispersing, agglutinant/humectant agents, and protectors againsc sunlight.

19. Process according to claim 14 wherein the dehydratation phase has been accomplished between the stages of addition of chemical dryers and the other addictives.

20. Process according to claim 14 wherein the dehydratation has been carried out in a stove under 30° C.

21. Process according to claim 14 wherein the tablets have been obtained by rotactive compression.

22. Process according to claim 18 wherein the addiction of protectors against sunlight has been carried out by means of a simple blend, or by a treatment of coating type.
